(19) United States
(12) Patent Application Publication
(10) Pub. No.: US 2025/0377455 A1
(43) Pub. Date: Dec. 11, 2025

(54) VEHICLE EQUIPPED WITH A SYSTEM FOR IDENTIFYING FOREIGN OBJECT OR DEBRIS ON RUNWAYS, DISCONTINUITIES OR FRACTURES IN A PAVEMENT

(71) Applicant: UNIVERSITA' DEGLI STUDI DI FIRENZE, Firenze (IT)

(72) Inventors: Massimiliano Pieraccini, Firenze (IT); Tommaso Consumi, Firenze (IT); Alessandra Beni, Firenze (IT)

(21) Appl. No.: 19/107,558

(22) PCT Filed: Jul. 27, 2023
(86) PCT No.: PCT/IT2023/050181

§ 371 Date: Feb. 27, 2025

(30) Foreign Application Priority Data
Aug. 29, 2022 (IT) 102022000017739

(51) Int. Cl. G01S 13/934; G01S 13/90; G06V 20/17; G06V 20/58

(52) U.S. Cl. CPC G01S 13/934; G01S 13/9021; G06V 20/17; G06V 20/58

(57) ABSTRACT

A vehicle is described, of the aircraft or Unmanned Aerial System (UAS) type, equipped with a system for the detection on runways of Foreign Objects or Debris (FOD), discontinuities or cracks in the pavement, the system comprising a broadband FM radar with a central frequency >20 GHZ, designed to acquire images of the runway and provide, by means of a Synthetic Aperture Radar (SAR) processing technique of the images, at least one high-resolution image of a surface of the runway to identify such foreign objects or debris, discontinuities or cracks in the pavement present on the surface, the vehicle being provided to move along the runway.

### BACKGROUND OF THE INVENTION

### 1) Field of the invention

The present invention refers to a vehicle of the aircraft or Unmanned Aerial System (“UAS”) type, equipped with an on-board system for identifying objects on runways, in particular airport runways or for car/motorcycle competitions. The objects can be Foreign Objects or Debris (“FOD”), discontinuities or cracks in the pavement.

### 2) Background art

It is known that the detection of foreign objects or debris, FOD, as well as discontinuities or cracks in the pavement, on a runway, especially on an airport runway, is a very serious problem (especially after the Concorde crash in July 2000). Currently, however, there are no effective techniques for the reliable, precise and substantially real-time identification of such foreign objects or debris other than visual inspection, which however can be very slow if performed with human operators.

In fact, solutions that use cameras or LIDARs and expert image recognition systems require high computational costs and, at least so far, do not give particularly satisfactory results.

A solution is also known which exploits the action of a synthetic aperture radar designed to see the surface of an airport runway from a grazing angle. However, this solution involves the use of a fixed installation (a so-called GBSAR, “Ground-Based Synthetic Aperture Radar”) which, consequently, can see only a small portion of the runway if not through the use of numerous other installations along the runway itself, with an obvious increase in installation and computational costs. Furthermore, this solution provides, representing a significant limit for the identification of small objects on a large surface such as that of an airport runway, a view with non-uniform resolution and dependent on the distance and the angle of view itself.

Other solutions are also known which envisage the use of remotely piloted aircraft (the so-called “UAS”, “Unmanned Aerial System”) for airport security and the identification of foreign objects or debris, some even capable of producing orthophotos for the inspection of airport runways: none of these solutions, however, provides for the use of a synthetic aperture radar (also known as “SAR”, “Synthetic Aperture Radar”), thus obtaining still unsatisfactory performance.

Documents CN-A-109 188 437, CN-A-113 447 926, CN-A-111 538 002, CN-A-113 406 639 and John Spriggs: “Runway Safety: Technologies for Debris Detection”, IIR Conference on Runway Safety, Oct. 25, 2001, XP002230491 describe systems according to the known prior art.

### SUMMARY OF THE INVENTION

Therefore, object of the present invention is solving the aforementioned prior art problems by providing a vehicle of the aircraft or UAS type, equipped with an on-board system for identifying foreign objects or debris on runways, discontinuities or fractures of the pavement, in which such vehicle exploits the synthetic aperture radar (“SAR”) processing technique for the acquisition of images of such runways, allowing to obtain better and more reliable performance compared to those proposed by the known art.

The above and other objects and advantages of the invention, as will become apparent from the following description, are achieved with a vehicle such as those described in claim 1.

Preferred embodiments and non-trivial variants of the present invention form the subject matter of the dependent claims.

It is understood that all attached claims form an integral part of the present description.

It will be immediately obvious that innumerable variations and modifications may be made to what is described (for example relating to shape, dimensions, arrangements and parts with equivalent functionality) without departing from the scope of the invention as appears from the attached claims.

### BRIEF DESCRIPTION OF THE DRAWINGS

The present invention will be better described by some preferred embodiments, provided by way of non-limiting example, with reference to the attached drawings, in which:

FIG. 1 shows a front view of a preferred embodiment of the vehicle according to the present invention;

FIG. 2 shows a schematic view of the operating principle of the vehicle and of the system according to the present invention;

FIGS. 3a, 3b and 3c show schematic views of an example of use of the vehicle and of the system according to the present invention; and
FIGS. 4 and 5 show diagrams relating to a test on the field of use of the vehicle and of the system according to the present invention.

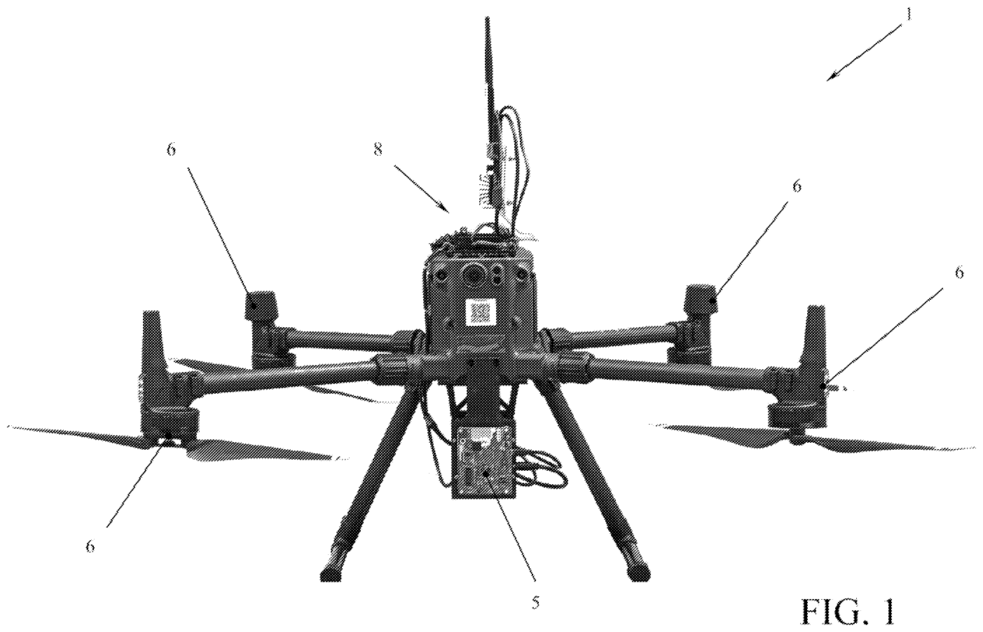

### DETAILED DESCRIPTION OF PREFERRED EMBODIMENTS

For sake of brevity, the descriptions relating to the parts and components common to other systems and vehicles of the known art and necessary for their basic operation, which are in any case considered widely known to the skilled people in the art, will obviously be omitted hereinafter, the description focusing on the aspects and components characterizing the system and the vehicle according to the present invention.

With reference therefore to the Figures, a preferred embodiment of the vehicle 1 of the aircraft or Unmanned Aerial System (UAS) type is shown, equipped with the system according to the present invention, for identification on runways 3, in particular airport runways or for automobile/motorcycle racing, of Foreign Objects or Debris (FOD) 7, discontinuities or cracks in the pavement.

This system comprises at least one broadband FM radar 5 with a central frequency >20 GHZ, designed to acquire images of a runway 3 and provide, by means of a synthetic aperture radar (“SAR”) processing technique of such images, at least one high-resolution image 9 (i.e., an image that has a longest side of at least 1920 pixels and a density of at least 300 pixels per inch (ppi), where 1 inch=25.4 mm) of a surface of the runway 3 to locate foreign objects or debris 7, discontinuities or cracks in the pavement present on the surface.

The inventive vehicle 1, equipped with the aforementioned system, is expected to move along the runway 3.

Advantageously, this vehicle 1 can indifferently be self-driving, semi-autonomous, remotely or humanly driven.

Similarly, this vehicle 1 can be equipped with its own autonomous propulsion means (such as, for example, a land engine with relative traction, one or more aircraft engines 6, etc.).

Preferably, the frequency indicated above is substantially equal to 77 GHz.

Preferably, this vehicle 1 moves substantially at a low altitude (no more than 5 meters above the ground) and with a grazing angle of view along a lateral trajectory X-X and substantially parallel to the runway 3, to allow the FM radar 5 to acquire one or more images of the surface of the runway 3 itself.

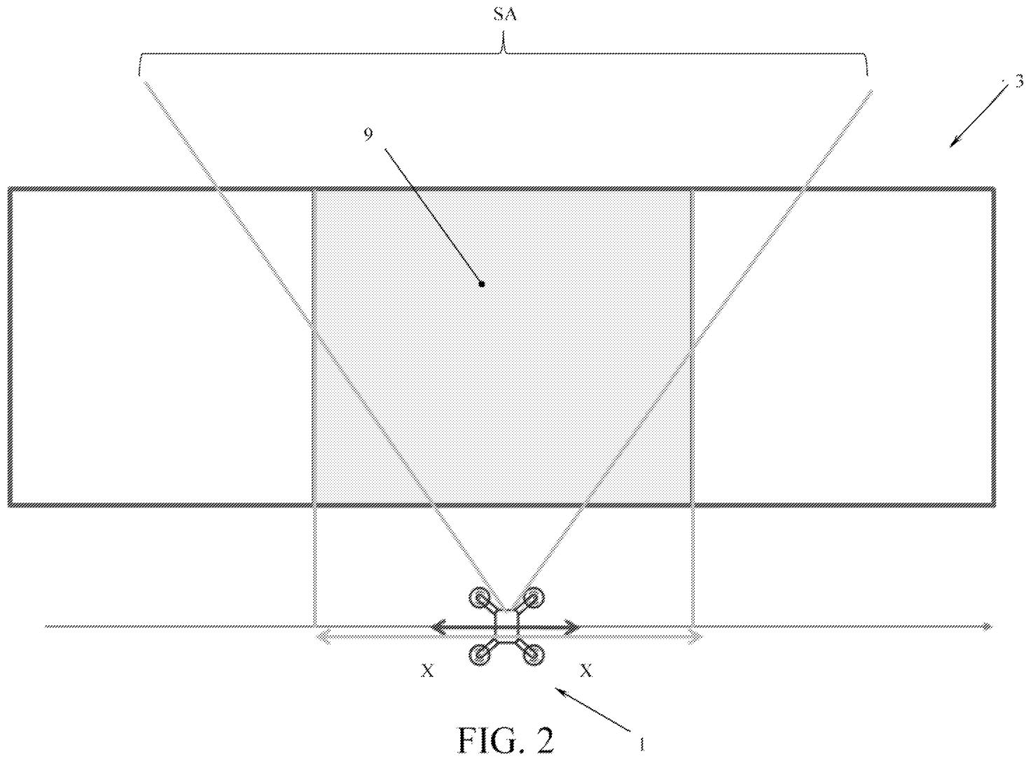

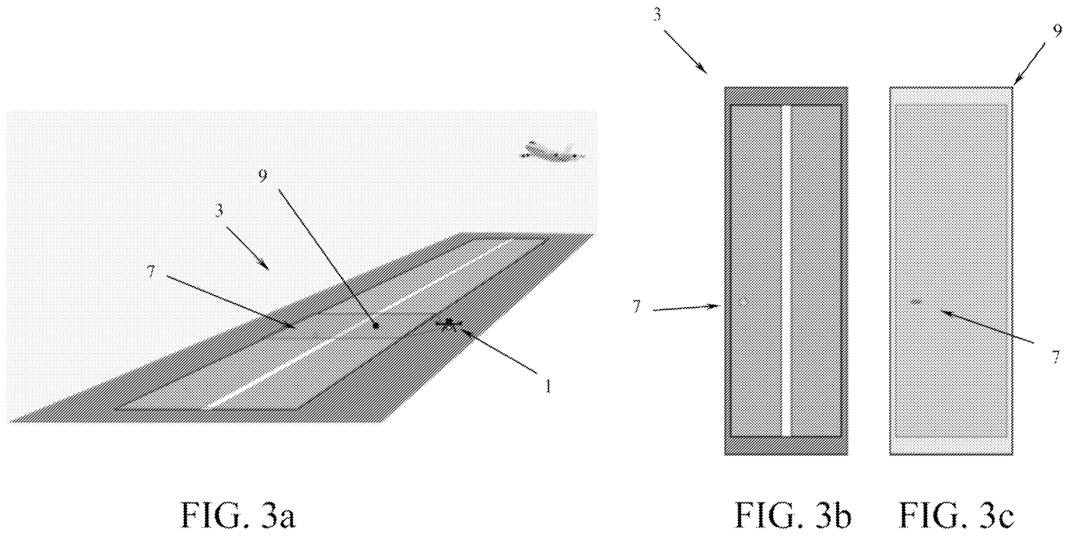

Referring in particular to FIG. 2, it is therefore possible to notice the movement of the vehicle 1 along an X-X direction laterally to the runway 3 in order to create a synthetic aperture by means of the FM radar 5 and the “SAR” processing technique to obtain an image 9 of the surface area of the runway 3 examined: preferably, the image 9 can also be obtained by means of a non-coherent sum with the previous images acquired by the FM radar 5 to compensate for any incorrect trajectories of the vehicle 1 along the runway 3.

The vehicle 1 can furthermore comprise means 8 for processing and feeding AI applications and devices, for example of the type based on the Jetson NANO™ platform by INVIDIA®.

In particular, FIGS. 3a, 3b and 3c show a schematic airport runway 3 along which, laterally and at a low altitude, the vehicle 1 moves for the acquisition of images 9 of the surface of the runway 3 itself, on which there is debris 7, a plan view of runway 3 (FIG. 3b) and an image 9 of the same runway 3 (FIG. 3c) obtained by means of the “SAR” processing technique with identification and evidence of debris 7.

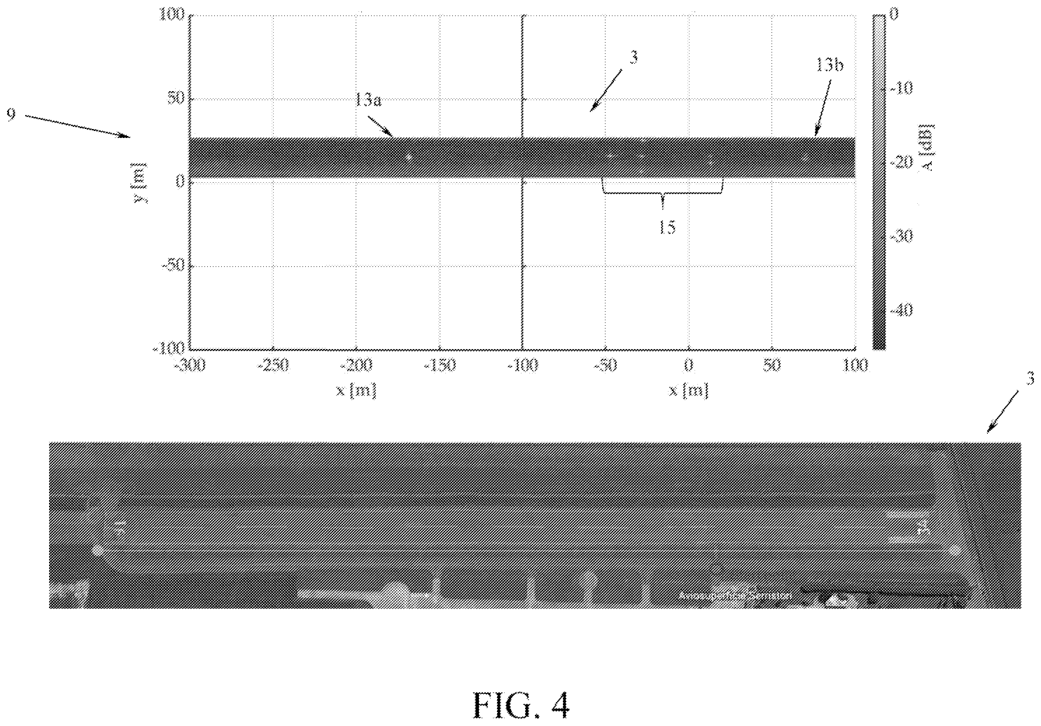

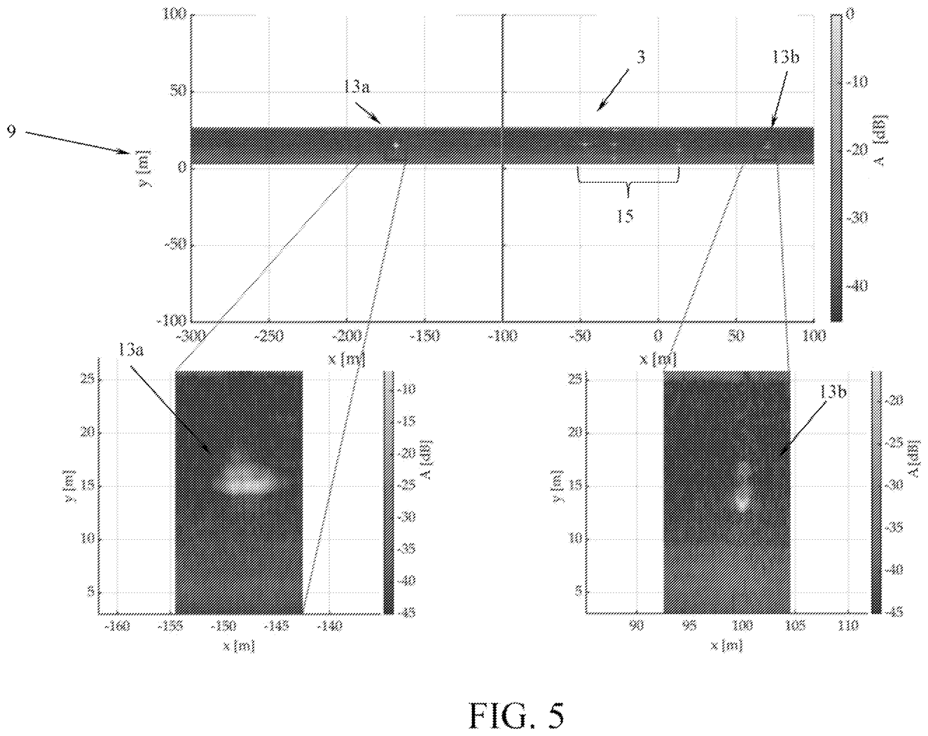

FIGS. 4 and 5 also show the results obtained during a field testing session of the vehicle 1 according to the present invention on a straight runway 3 on which discontinuities or fractures were arranged as target objects representing foreign objects or debris (FOD) of the pavement to be identified, two cars and various corner reflectors: these Figures therefore show, in the related diagrams, in which the left vertical axis y and the horizontal x axis represent longitudinal and lateral distances of the runway 3 while the right vertical axis A represents an amplitude measurement, the surface image 9 of the runway 3 obtained from the vehicle 1 with the system according to the present invention, through the movement of the vehicle 1 along the runway 3 itself in the manner indicated above, in which the target objects, such as the two cars 13a and 13b and the reflectors 15, are shown.

The installation of the radar on board a vehicle as indicated above therefore has the great advantage, with respect to what is proposed by the prior art, of being able to scan the entire length of the runway 3 while keeping the resolution of the image 9 uniform, obtained by means of the SAR processing.

The vehicle according to the present invention also makes it possible to obtain the following technical advantages with respect to what is proposed by the prior art:
the use of a broadband FM radar 5 with central frequency >20 GHz allows for a good signal/noise ratio even from small debris or discontinuities (up to the order of a millimeter);
the movement of the vehicle 1 along the runway 3 with a grazing angle of view avoids the reflection of the ground and therefore allows having a signal only from the small discontinuities of the surface; the grazing angle of view also allows maximum resolution in the direction of view of the FM radar 5;
the exploitation of the “SAR” processing technique makes it possible to obtain very high resolutions, theoretically of a few millimeters, by exploiting the movement of the vehicle 1 orthogonal to the direction of view of the runway 3;
it is also possible to envisage exploiting a “SAR” processing technique with compensation of the not completely straight trajectory of the vehicle 1;
it is also possible to envisage exploiting a 2-step SAR processing technique (coherent sum and non-coherent sum) particularly robust to compensation errors of the not completely straight trajectory even without autofocusing techniques, which are very heavy from a computational point of view;
it is possible to obtain a radar image 9 from both sides of the runway 3 with processing on the same grid, allowing the identification of foreign objects or debris (FOD) 7, discontinuities or fractures of the pavement of such shapes as to be hardly visible on one side only.

What is claimed is:

1. A vehicle of an aircraft or Unmanned Aerial System (UAS) type, the vehicle being equipped with a system for identifying on runways foreign objects or debris, discontinuities or cracks in a pavement, the system comprising:
at least one broadband FM radar, designed to acquire images of the runway and provide, by means of a processing technique with Synthetic Aperture Radar (“SAR”) of the images, at least one high resolution image of a surface of the runway to locate the foreign objects or debris, discontinuities or cracks in the pavement present on the surface,
the vehicle being intended to move along the runway,
wherein:
the at least one broadband FM radar has a central frequency >20 GHZ;
the at least one high resolution image is an image that has its longest side of at least 1920 pixels and a density of at least 300 pixels per inch,
the vehicle moves substantially at a low altitude, i.e. a height lower than or equal to 5 m, and with a grazing angle of view along a lateral trajectory and substantially parallel to the runway to allow the FM radar to acquire one or more images of the surface of the runway orthogonal to the direction of view of the runway.

2. The vehicle of claim 1, wherein the vehicle is self-driving, semi-autonomous, remotely or human driven.

3. The vehicle of claim 1, wherein the vehicle is equipped with its own autonomous propulsion means.

4. The vehicle of claim 1, wherein the frequency is substantially equal to 77 GHz.

5-6: (canceled)
